(19) United States
(12) Patent Application Publication
(10) Pub. No.: US 2006/0044992 A1
(43) Pub. Date: Mar. 2, 2006

(54) Optical recording medium

(75) Inventors: Jun-ichi Satoh, Tokyo (JP); Yoshimi Sakai, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/172,969

(22) Filed: Jul. 5, 2005

(30) Foreign Application Priority Data
Jul. 6, 2004 (JP) 2004-003966

(51) Int. Cl. G11B 7/24

(52) U.S. Cl. 369/272.1; 369/275.1

(57) ABSTRACT

An optical recording medium that is a DVD includes an ink receiving layer and a white underlayer on a label surface side of a disc body. Inner circumferential ends of a reflective layer in an information area, the ink receiving layer, and the white underlayer that are closer to a center of the disc body are arranged inside an inner circumferential end of the information area in a radial direction by about 3 to about 15 mm. Thus, even if a label surface is enlarged toward a center of the optical recording medium, a level of whiteness is not lowered in an enlarged region.

### BACKGROUND OF THE INVENTION

1. Field of the Invention

The present invention relates to an optical recording medium. More particularly, the present invention relates to an optical recording medium that allows printing to be performed for a label surface that is opposite to a light-incident surface.

2. Description of the Related Art

In CDs (Compact Disc) and DVDs (Digital Versatile Disc), a write-once type optical recording medium and a rewritable type one are especially in widespread use in recent years, which allow a user to perform recording of data.

As one of the above-mentioned type of optical recording medium, an optical recording medium is proposed that allows the user to print information indicating a recorded content onto a label surface (that is opposite to a light-incident surface) of that optical recording medium in the case where the user has recorded digital data such as image data or music data onto the optical recording medium on his/her own (see Japanese Patent Laid-Open Publication No. 2000-149333).

A printable area on the label surface is called as a print area. The print area is typically formed to be visually white and is provided with an ink receiving layer so as to allow ink to be fixed onto the label surface side of the optical recording medium.

It is expected that next-generation DVD be commercialized more recently and therefore the aforementioned demand further increase.

Many users have a request for enlargement of the ink receiving layer in order to print more information. In case of enlarging the ink receiving layer, the enlargement is made toward a center of the disc. However, when the ink receiving layer is simply enlarged, a level of whiteness is lowered in an enlarged region because the ink receiving layer is seen through. Thus, the content recorded in the enlarged region is not clear.

### SUMMARY OF THE INVENTION

In view of the foregoing problems, various exemplary embodiments of this invention provide an optical recording medium including an ink receiving layer that can be enlarged toward a center of the optical recording medium without lowering a level of whiteness in an enlarged region, thereby making print clear.

Accordingly, various exemplary embodiments of the invention provide the following aspects.

(1) An optical recording medium includes: a disc body having an information area provided outside a definite region formed in an inner circumferential part of the disc body; an ink receiving layer provided on a label surface side of the disc body that is opposite to an incident side on which recording and reproduction light is incident; and an inorganic material layer formed to correspond to an entire region of the information area, wherein inner circumferential ends of the inorganic material layer and the ink receiving layer are arranged inside an inner circumferential end of the information area in a radial direction by about 3 to about 15 mm.

(2) In the optical recording medium described in (1), the inorganic material layer is provided on a surface of the disc body that is opposite to the ink receiving layer.

(3) An optical recording medium includes: a light transmitting disc body having an information area provided outside a definite region formed in an inner circumferential part of the disc body; an ink receiving layer provided on a label surface side of the disc body, the label surface side being opposite to an incident side on which recording and reproduction light is incident; and a reflective layer that is formed by an inorganic material layer to cover a recording layer formed to correspond to an entire region of the information area, the reflective layer being adjacent to a side of the recording layer that is opposite to a light-incident side, wherein the ink receiving layer and the reflective layer are arranged in such a manner that inner circumferential ends thereof that are closer ends to a center of the disc body are located inside an inner circumferential end of the information area in a radial direction by about 3 to about 15 mm.

(4) In the optical recording medium described in any one of (1) to (3), the ink receiving layer is transparent and a white underlayer is provided under the ink receiving layer.

(5) In the optical recording medium described in any one of (1) to (3), the ink receiving layer is white.

(6) An optical recording medium includes: a disc body having a center hole for chucking at its center; and at least an inorganic material layer and an ink receiving layer, wherein inner circumferential ends of the inorganic material layer and the ink receiving layer are located outside the center hole in a radial direction by 0.5 to 10 mm.

(7) In the optical recording medium described in (6), the inner circumferential ends of the inorganic material layer and the ink receiving layer are located outside the center hole in the radial direction by 0.5 to 5 mm.

(8) In the optical recording medium described in (6) or (7), the ink receiving layer is provided on one side of the disc body and the inorganic material layer is provided on another side of the disc body.

(9) In the optical recording medium described in any one of (6) to (8), the ink receiving layer is transparent and a white underlayer is provided under the ink receiving layer.

(10) In the optical recording medium described in any one of (6) to (8), the ink receiving layer is white.

(11) In the optical recording medium described in any one of (1) to (10), a hard coating layer covers a surface of the incident side of the disc body.

In the present invention, the ink receiving layer and the reflective layer formed by the inorganic material layer are enlarged in the inside of the inner circumferential end of the information area so as to reach a region near the center hole of the optical recording medium. Thus, the present invention has an advantageous effect that a level of whiteness is not lowered in an enlarged region of the ink receiving layer in the case where the ink receiving layer is seen through. Therefore, it is possible to see print clearly throughout the ink receiving layer.

### BRIEF DESCRIPTION OF THE DRAWINGS

FIG. 1 is an enlarged cross-sectional view schematically showing a main part of an optical recording medium according to a first exemplary embodiment of the present invention;

FIG. 2 is a plan view of a label surface of the optical recording medium of the first exemplary embodiment;

FIG. 3 is an enlarged cross-sectional view schematically showing a main part of an optical recording medium according to a second exemplary embodiment of the present invention; and

FIG. 4 is a cross-sectional view showing an optical recording medium according to a third exemplary embodiment of the present invention in a similar manner to FIG. 1.

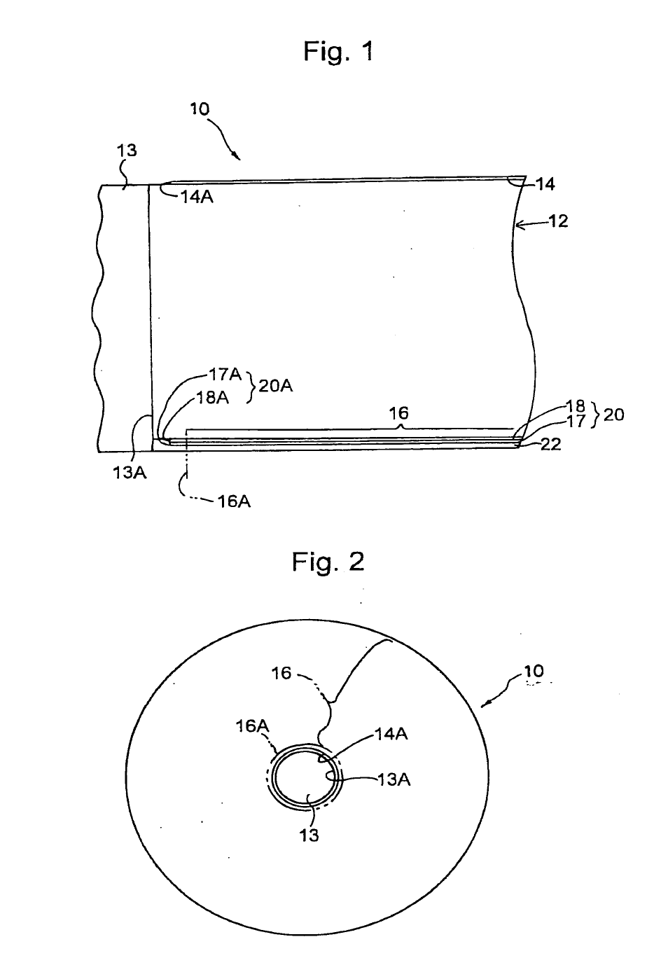

### DETAILED DESCRIPTION OF THE PREFERRED INVENTION

An optical recording medium is a DVD-R/RW disc, and includes a light transmitting disc body, a white ink receiving layer provided on a label surface side of the disc body, and a reflective layer that is formed by an inorganic material layer on a side of a recording layer that is opposite to a light-incident side. The recording layer is provided to cover an information area. The ink receiving layer and the reflective layer are arranged in such a manner that inner circumferential ends thereof that are closer ends to a center of the disc body are located inside of an inner circumferential end of the recording layer in a radial direction by about 3 to about 15 mm.

In case of DVD-R, the reflective layer formed by the inorganic material layer corresponds to an inorganic material layer of the present invention because the recording layer is formed of a dye material. However, in case of DVD-RW, the recording layer is also formed of an inorganic material and therefore the reflective layer can serve as the inorganic material layer of the present invention, instead of the recording layer. The inorganic material layer is formed by sputtering.

As for the above optical recording medium, it is defined that an inner circumference of the information area has a radius of 22 mm. A position inside the inner circumferential end of the information area in the radial direction by 3 to 15 mm corresponds to a position away from the center of the optical recording medium in the radial direction by 7 to 19 mm.

In other words, the center hole of the optical recording medium has a radius of 7.5 mm and the inner circumferential ends of the ink receiving layer and the inorganic material layer are formed within an area with a 19-mm radius from the center of the optical recording medium. Thus, in order to sufficiently achieve the advantageous effect of the present invention, it is preferable that the inner circumferential ends of the ink receiving layer and the inorganic material layer be located outside the end of the center hole in the radial direction by 0.5 to 5 mm.

Especially, since the inorganic material layer is formed on the disc body by sputtering, it is preferable to form a resin layer (resin protection layer) to cover the inorganic material layer in order to prevent corrosion and peeling of the inorganic material layer caused by moisture entering an interface between the disc body and the inorganic material layer. Taking this into consideration, it is preferable to arrange the inner circumferential end of the inorganic material layer outside the end of the center hole in the radial direction hole by 0.5 mm or more.

The disc body is formed by injection molding. In a structure of a mold that is presently used, it may be required to ensure a necessary mold area for a groove formed by stampering or a stack ring. Thus, it is preferable to arrange the inner circumferential end of the inorganic material layer within 10 mm, more preferably, 5 mm from the end of the center hole in the radial direction.

Although the above description is made with reference to an example of DVD-R/RW, it can be also applied to next-generation DVD that has the same shape as that of DVD-R/RW and is adopted for the blue laser specification.

A first exemplary embodiment of the present invention will be described with reference to the drawings, in which the present invention is applied to a Blu-ray (trademark) disc that is an optical recording medium 10 adopted for the blue laser specification.

The optical recording medium 10 has a center hole 13 having a radius of 7.5 mm, and includes a disc body 12 that does not have to have a light-transmitting property, a white ink receiving layer 14 provided on a label surface side of the disc body 12, and an inorganic material layer 20 provided on a surface of the disc body 12 that is opposite to the label surface. The inorganic material layer 20 includes a recording layer 17 and a reflective layer 18 that are formed to correspond to an entire region of an information area 16. A light transmitting layer 22 is also formed on the surface opposite to the label surface so as to cover the recording layer 17 and the reflective layer 18. The light transmitting layer 22 is formed by attaching a resin sheet or applying a resin material and then hardening it.

In this case, the ink receiving layer 14 is opposed to the recording layer 17 and the reflective layer 18 of the inorganic material layer 20 with the disc body 12 interposed therebetween. Moreover, inner circumferential ends 14A, 20A, 17A, and 18A of the ink receiving layer 14, the inorganic material layer 20, the recording layer 17, and the reflective layer 18 are arranged inside an inner circumferential end 16A of the information area 16 in the radial direction by about 3 to about 15 mm.

The recording layer 17 is also formed of an inorganic material in the optical recording medium 10. Thus, the recording layer 17 may also serve as the inorganic material layer of the present invention, instead of the reflective layer 18.

It is defined in this type of optical recording medium 10 that the information area 16 is provided outside a radius of 22 mm. Thus, to arrange the inner circumferential ends 14A, 20A, 17A, and 18A inside the information area 16 by 3 to 15 mm in the radial direction means to arrange them in a ring-like region having an inner circumferential radius of 7 mm and an outer circumferential radius of 19 mm.

In other words, the radius of the center hole 13 is 7.5 mm and the inner circumferential ends 14A and 20A of the ink receiving layer 14 and the inorganic material layer 20 (inner circumferential ends 17A and 18A) are arranged in a region between the circumference 13A of the center hole and a circle having a radius of 19 mm. Thus, it is preferable that the inner circumferential ends of the ink receiving layer 14 and the inorganic material layer 20 be located outside the circumference 13A of the center hole in the radial direction by 0.5 to 5 mm in order to sufficiently achieve an effect of the first exemplary embodiment.

Especially, since the inorganic material layer 20 is formed by sputtering, it is preferable to form a resin layer (resin protection layer) 15 to cover the inorganic material layer 20 in order to prevent occurrence of corrosion and peeling of the inorganic material layer 20 caused by moisture entering an interface between the disc body 12 and the inorganic material layer 20 formed on the disc body 12. Taking this into consideration, it is preferable to arrange the inner circumferential end 20A of the inorganic material layer 20 outside the circumference 13A of the center hole in the radial direction by 0.5 mm or more.

Moreover, it is preferable to arrange the inner circumferential end 20A of the inorganic material layer 20 within 10 mm, more preferably, 5 mm from the circumference 13A of the center hole 13 in the radial direction. This is because it may be requested to ensure a necessary mold area for a groove formed by stampering or a stack ring in a structure of a mold that is presently used, when the disc body 12 is formed by injection molding.

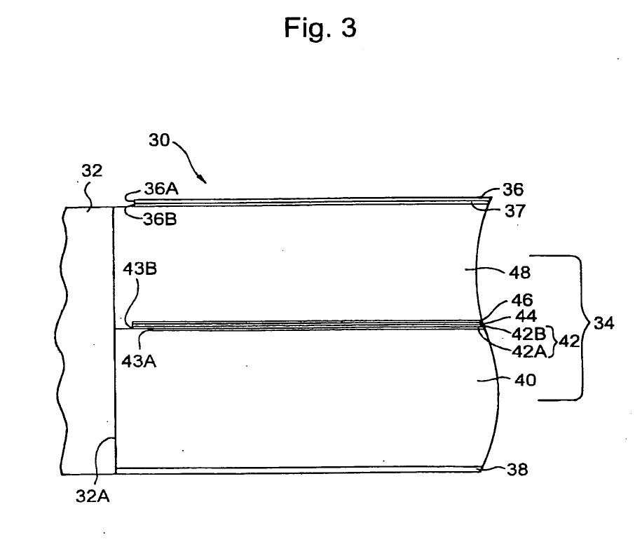

A second exemplary embodiment of the present invention will be described with reference to FIG. 3.

As shown in FIG. 3, an optical recording medium 30 of the second exemplary embodiment is a typical DVD, and includes a light transmitting disc body 34 having a circular center hole 32 at its center, an ink receiving layer 36 provided on a label surface side of the disc body 34, and a hard coating layer 38 formed to cover a light-incident side of the disc body 34. The ink receiving layer 36 is transparent. A white underlayer 37 is provided between the label surface of the disc body 34 and the ink receiving layer 36.

The disc body 34 is composed of a light transmitting substrate 40, a function layer 42, a protection layer 44, an adhesive layer 46, and a dummy substrate 48 in that order from the hard coating layer 38.

The function layer 42 is formed by a recording layer 42A on the light-transmitting substrate 40 side and a reflective layer 42B provided on an opposite side of a light-incident surface side. In a conventional DVD, the inner circumferential ends of the recording layer and the reflective layer of the function layer and the inner circumferential end of the ink receiving layer are coincident with each other. On the other hand, in this exemplary embodiment, the inner circumferential ends 36A, 36B, and 43B of the ink receiving layer 36, the white underlayer 37, and the reflective layer 42B are arranged inside the inner circumferential end 43A of the recording layer 42A in the radial direction by about 3 to about 15 mm.

The hard coating layer 38 is formed of a coating material containing colloidal silica having a small grain size by spin coating, as described in Japanese Patent Laid-Open Publication No. 2002-234906, for example.

Since the reflective layer 42B is also formed behind the ink receiving layer 36 and the white underlayer 37 in the optical recording medium 30 of the second exemplary embodiment, the ink receiving layer 36 and the white underlayer 37 are not seen through. Thus, a user can print information clearly even in a region near the center of the optical recording medium 30.

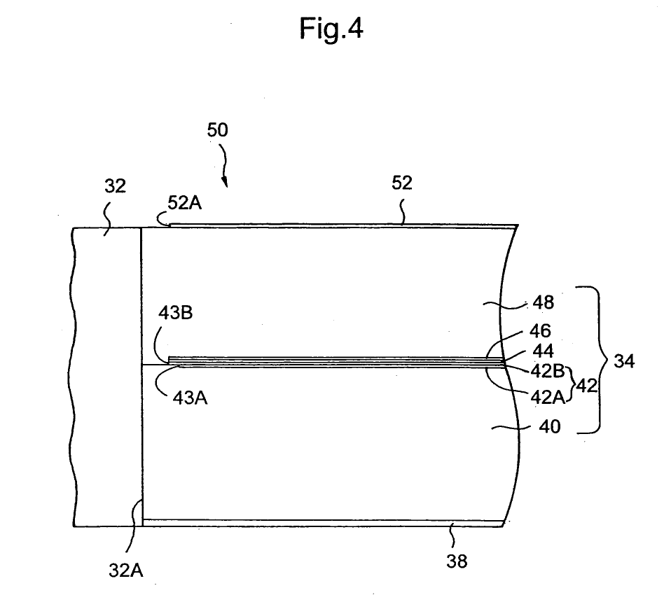

An optical recording medium 50 of a third exemplary embodiment of the present invention is described with reference to FIG. 4.

The optical recording medium 50 includes a white ink receiving layer 52 in place of the ink receiving layer 36 and the white underlayer 37 in the above optical recording medium 30. The reference numeral 52A in FIG. 4 represents an inner circumferential end of the white ink receiving layer 52.

Except for the above, the optical recording medium 50 is the same as the optical recording medium 30. Thus, the same components of the optical recording medium 50 as those of the optical recording medium 30 are labeled with the same reference numerals as those in FIG. 3 and the description thereof is omitted.

The position of the inner circumferential end 43B of the reflective layer 42B in the radial direction is coincident with the positions of the inner circumferential ends 36A and 36B of the ink receiving layer 36 and the white underlayer 37 in the second exemplary embodiment, or is coincident with the inner circumferential end 52A of the white ink receiving layer 52 in the third exemplary embodiment. However, when the position of the inner circumferential end 43B of the reflective layer 42B is arranged inside the other inner circumferential end 36A, 36B, or 52A slightly (by 1 mm, for example), misalignment and decentering when the optical recording medium is seen from the ink receiving layer side can be prevented.

In the second and third exemplary embodiments, the hard coating layer 38 is formed in order to protect the light-incident surface of the optical recording medium. However, the present invention can be applied to a case where no hard coating layer is provided. Moreover, the present invention can be applied to an optical recording medium having no recording layer, although the recording layer is included in the inorganic material layer in the first to third exemplary embodiments.

The first to third exemplary embodiments are related to DVDs and next-generation DVDs. However, the present invention can be also applied to CDs.

What is claimed is:

1. An optical recording medium comprising:
a disc body having an information area provided outside a definite region formed in an inner circumferential part of the disc body;
an ink receiving layer provided on a label surface side of the disc body that is opposite to an incident side on which recording and reproduction light is incident; and
an inorganic material layer formed to correspond to an entire region of the information area, wherein
inner circumferential ends of the inorganic material layer and the ink receiving layer are arranged inside an inner circumferential end of the information area in a radial direction by about 3 to about 15 mm.

2. The optical recording medium according to claim 1, wherein
the inorganic material layer is provided on a surface of the disc body that is opposite to the ink receiving layer.

3. An optical recording medium comprising:
a light transmitting disc body having an information area provided outside a definite region formed in an inner circumferential part of the disc body;
an ink receiving layer provided on a label surface side of the disc body, the label surface side being opposite to an incident side on which recording and reproduction light is incident; and
a reflective layer that is formed by an inorganic material layer to cover a recording layer formed to correspond to an entire region of the information area, the reflective layer being adjacent to a side of the recording layer that is opposite to a light-incident side, wherein
the ink receiving layer and the reflective layer are arranged in such a manner that inner circumferential ends thereof that are closer ends to a center of the disc body are located inside an inner circumferential end of the information area in a radial direction by about 3 to about 15 mm.

4. The optical recording medium according to claim 1, wherein
the ink receiving layer is transparent and a white underlayer is provided under the ink receiving layer.

5. The optical recording medium according to claim 2, wherein
the ink receiving layer is transparent and a white underlayer is provided under the ink receiving layer.

6. The optical recording medium according to claim 3, wherein
the ink receiving layer is transparent and a white underlayer is provided under the ink receiving layer.

7. The optical recording medium according to claim 1, wherein
the ink receiving layer is white.

8. The optical recording medium according to claim 2, wherein
the ink receiving layer is white.

9. The optical recording medium according to claim 3, wherein
the ink receiving layer is white.

10. An optical recording medium comprising:
a disc body having a center hole for chucking at its center; and
at least an inorganic material layer and an ink receiving layer, wherein
inner circumferential ends of the inorganic material layer and the ink receiving layer are located outside the center hole in a radial direction by 0.5 to 10 mm.

11. The optical recording medium according to claim 10, wherein
the inner circumferential ends of the inorganic material layer and the ink receiving layer are located outside the center hole in the radial direction by 0.5 to 5 mm.

12. The optical recording medium according to claim 10, wherein
the ink receiving layer is provided on one side of the disc body and the inorganic material layer is provided on another side of the disc body.

13. The optical recording medium according to claim 11, wherein
the ink receiving layer is provided on one side of the disc body and the inorganic material layer is provided on another side of the disc body.

14. The optical recording medium according to claim 10, wherein
the ink receiving layer is transparent and a white underlayer is provided under the ink receiving layer.

15. The optical recording medium according to claim 11, wherein
the ink receiving layer is transparent and a white underlayer is provided under the ink receiving layer.

16. The optical recording medium according to claim 12, wherein
the ink receiving layer is transparent and a white underlayer is provided under the ink receiving layer.

17. The optical recording medium according to claim 10, wherein
the ink receiving layer is white.

18. The optical recording medium according to claim 11, wherein
the ink receiving layer is white.

19. The optical recording medium according to claim 12, wherein
the ink receiving layer is white.
